(19) United States
(12) Patent Application Publication
(10) Pub. No.: US 2015/0002473 A1
(43) Pub. Date: Jan. 1, 2015

(54) Optical Touch Panel Device and Optical Touch Panel System Incorporating the Same

(71) Applicant: Wistron Corporation, New Taipei City (TW)

(72) Inventors: Po Liang Huang, New Taipei City (TW); Yu Kai Su, New Taipei City (TW); Chia Jui Liu, New Taipei City (TW); Chun Chieh Li, New Taipei City (TW)

(73) Assignee: Wistron Corporation, New Taipei City (TW)

(21) Appl. No.: 14/091,763

(22) Filed: Nov. 27, 2013

(30) Foreign Application Priority Data
Jun. 28, 2013 (TW) 102212222

(51) Int. Cl. G06F 3/042; G06F 3/0354

(52) U.S. Cl. CPC G06F 3/042; G06F 3/03545
USPC 345/175

(57) ABSTRACT

An optical touch panel device is adapted to be operable with a stylus. The stylus has a touch portion and a light-emitting portion that is connected to the touch portion and that emits light when the touch portion is touched. The optical touch panel device includes a back housing having an opening, a transparent panel sealing the opening of the back housing, at least two optical sensors disposed in the back housing and adapted to sense the light from the light-emitting portion of the stylus, and a processing module coupled to the optical sensors for determining a position on the transparent panel at which the touch portion of the stylus touches based on the light detected by the optical sensors.

### CROSS-REFERENCE TO RELATED APPLICATION

This application claims priority of Taiwanese Application No. 102212222, filed on Jun. 28, 2013.

### BACKGROUND OF THE INVENTION

1. Field of the Invention

The invention relates to an optical touch panel system, particularly to an optical touch panel device that has a completely flat operating side, and an optical touch panel system incorporating the same.

2. Description of the Related Art

Touch panel devices have become common appliances in our daily lives as touch controlled electronics such as tablet pc, smart phones and e-books are gaining popularity. Amongst various touch panel technologies, optical touch panel devices have price advantages and therefore play an important role in the development of touch panel devices.

A conventional optical touch panel device typically includes a display panel, a transparent touch panel laid on the display panel, two cameras disposed on the transparent touch panel, two light emitting devices respectively disposed by the two cameras and a retro-reflector disposed on and extending along edges of the transparent touch panel.

In practice, the cameras detect the reflections by the retro-reflector of the light emitted by the light emitting devices. Part of the light reflections is interrupted when a user's finger touches on the transparent touch panel. The position of the finger is acquired by analyzing the light reflections as detected by the cameras.

However, the cameras, the light emitting devices and the retro-reflector are all disposed on top of the transparent touch panel in the conventional optical touch panel device; therefore, a fully flat surface cannot be achieved and thus application of the conventional optical touch panel device is restricted. In addition, the costly retro-reflector increases the cost of the conventional optical touch panel device drastically. Furthermore, gaps amongst components such as the cameras and the light emitting devices and the transparent touch panel make it difficult for water and dust proofing. Therefore, there is room for improvement in the conventional optical touch panel device.

### SUMMARY OF THE INVENTION

Therefore, the object of the present invention is to provide an optical touch panel device that can overcome the aforesaid drawbacks associated with the prior art, and an optional touch panel system incorporating the same.

Accordingly, an optical touch panel system of the present invention includes an optical touch panel device and a stylus. The stylus has a touch portion and a light-emitting portion that is connected to the touch portion and that emits light when the touch portion is touched.

The optical touch panel device includes a back housing having an external hole-defining surface that defines an opening, a transparent panel attached to the back housing, sealing the opening and being flush with the hole-defining surface of the back housing, at least two optical sensors spaced apart from each other, disposed in the back housing, and sensing light from the light-emitting portion of the stylus when the touch portion of the stylus touches the transparent panel, and a processing module coupled to the optical sensors for determining a position on the transparent panel at which the touch portion of the stylus touches based on the light detected by the optical sensors.

### BRIEF DESCRIPTION OF THE DRAWINGS

Other features and advantages of the present invention will become apparent in the following detailed description of the preferred embodiments with reference to the accompanying drawings, of which:

FIG. 1 is a perspective view of the first preferred embodiment of an optical touch panel system according to the present invention;

FIG. 2 is a fragmentary schematic diagram illustrating the top view of the first preferred embodiment;

FIG. 3 is a sectional view taken along line III-III of FIG. 2, illustrating the configurations of internal components in an optical touch panel device of the first embodiment;

FIG. 4 is a sectional view similar to FIG. 3 illustrating the optical touch panel device according to the second preferred embodiment of the present invention.

### DETAILED DESCRIPTION OF THE PREFERRED EMBODIMENTS

Before the present invention is described in greater detail, it should be noted that like elements are denoted by the same reference numerals throughout the disclosure.

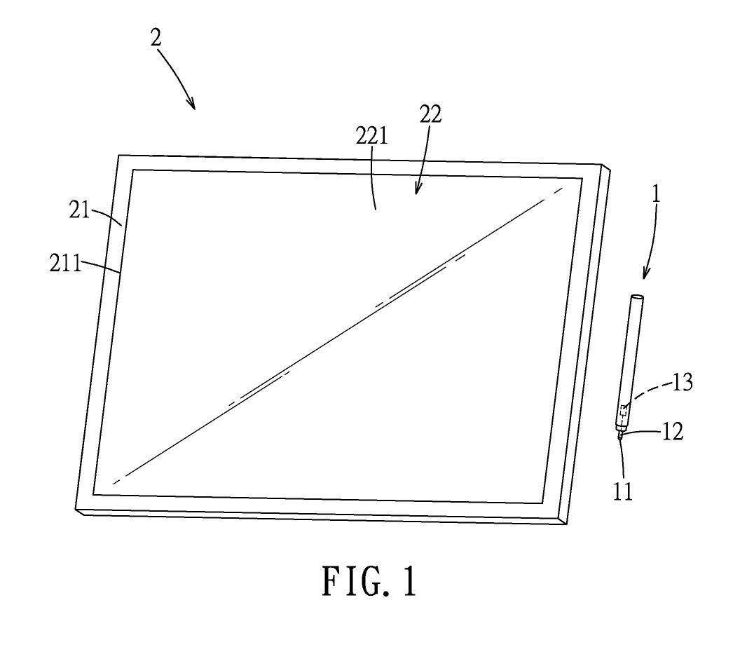

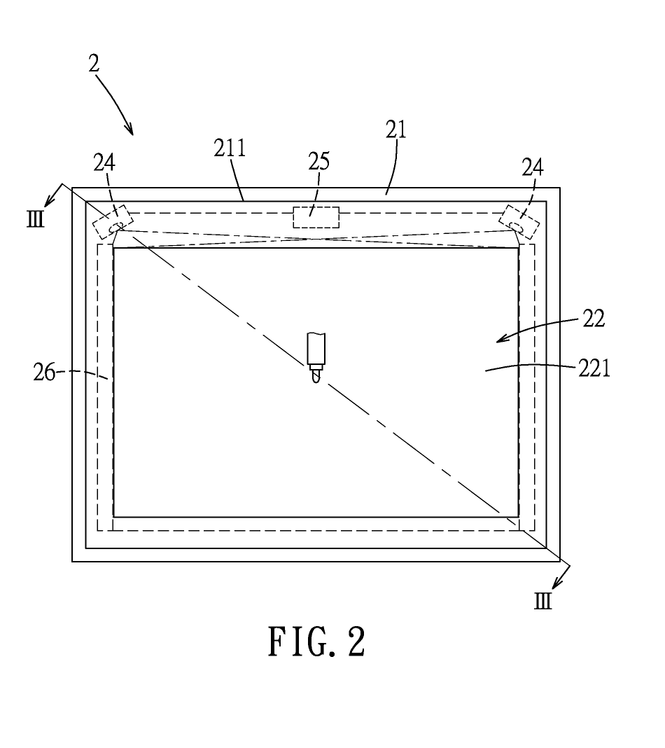

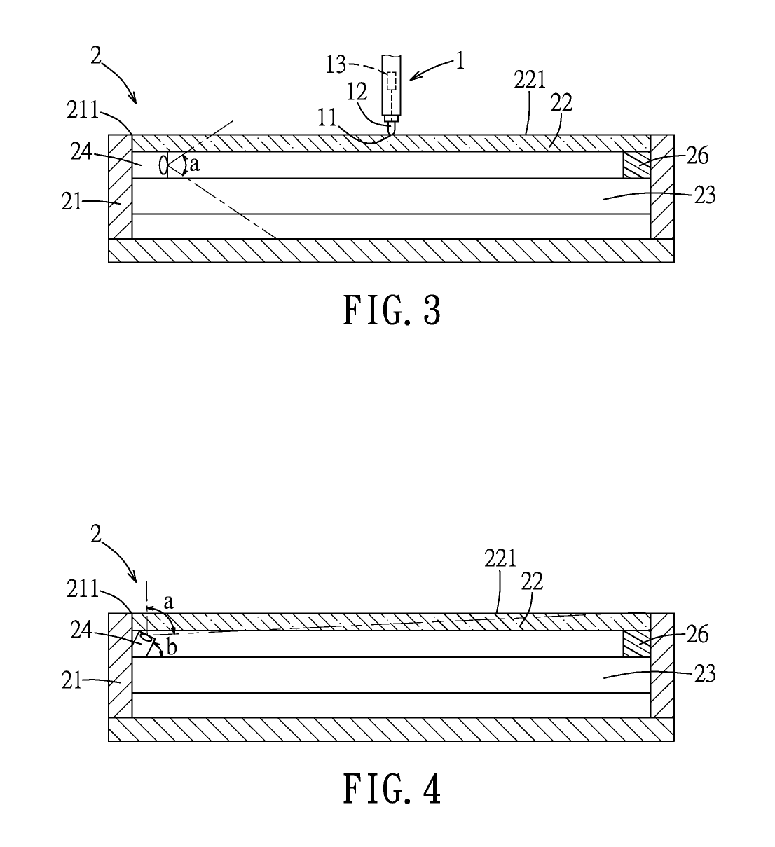

FIGS. 1 to 3 illustrate the first preferred embodiment of an optical touch panel system according to the present invention. The system includes a stylus 1 and an optical touch panel device 2. The stylus 1 includes a touch portion 11, a light-emitting portion 12 connected to the touch portion 11, and a control module 13 connected to the touch portion 11 and light-emitting portion 12. The control module 13 detects whether the touch portion 11 is touched or not. When it is detected that the touch portion 11 is touched, the control module 13 drives the light-emitting portion 12 to emit light. When no touch is detected, the control module 13 ceases to drive the light-emitting portion 12 to emit the light, thereby prevents the optical touch panel device 2 from receiving the light from the stylus when the touch portion 11 is not in contact with the optical touch panel device 2.

The optical touch panel device 2 includes a back housing 21 having an external hole-defining surface that defines an opening 211, a transparent panel 22 attached to the back housing 21, a display panel 23 disposed in the back housing 21, at least two optical sensors 24 spaced apart from each other and disposed in the back housing 21, a processing module 25 coupled to the optical sensors 24, and a support member 26 clamped cooperatively by the display panel 23 and the transparent panel 22. The transparent panel 22 seals the opening 211 and a fully flat touch surface 221 that is flush with the hole-defining surface of the back housing 21. The display panel 23 is spaced apart from the transparent panel 22.

The two optical sensors 24 are disposed between the transparent panel 22 and the display panel 23 and respectively proximate to two adjacent corners of the transparent panel 22. The optical sensors 24 detect the light emitted by the light emitting portion 12 of the stylus 1 when the touch portion 11 of the stylus 1 is in contact with the touch surface 221 of the transparent panel 122 with a detection range (a) that covers a majority of the touch surface 221. The processing module 25 the light detected by the optical sensors 24 at which the touch portion 11 touches based on determines a position of the touch portion 11 on the touch surface 221. It should be noted that in order to increase the reliability of light detection, the light-emitting portion 12 of the stylus 1 is configured to be elongated to have an emitting portion bigger than a point light source for easier light detection by the optical sensors 24.

The support member 26 extends along the edges of the transparent panel 22 and supports the transparent panel 22 at a distance apart from the display panel 23 sufficient for accommodating the optical sensors 24 without damaging the same. It is emphasized in this embodiment that the support member 26 is water proof and is configured as a strip extending along the junction between the transparent panel 22 and the back housing 21 to provide for enhanced water proofing ability to the optical touch panel device 2.

Since the optical sensors 24 are disposed within the back housing 21 and between the transparent panel 22 and display panel 23 and since placement of the light-emitting device of the conventional optical touch panel device is not required on the touch surface 221, a fully flat top surface optical touch panel device 2 can be achieved by ensuring that the touch surface 221 of the transparent panel 22 and the external hole-defining surface of the back housing 21 are flush with each other. Application of the optical touch panel device 2 can be greatly extended, e.g., to a touch panel conference table. In addition, since the light being detected by the optical sensors 24 is directly emitted from the light-emitting portion 12 of the stylus 1 into the transparent panel 22, a light emitting device and a costly retro-reflector of the conventional optical touch panel device are not required, and therefore the overall cost of the optical touch panel device 2 is significantly reduced. Furthermore, because no component is required on the touch surface 221 of the transparent panel 22, no gap would exist between such component and the touch surface 221, and the optical touch panel device 2 has better water and dust proofing abilities.

FIG. 4 shows an optical touch panel device 2 according to the second preferred embodiment of the present invention. The second preferred embodiment is similar to the first preferred embodiment, except that the optical sensors 24 (only one is shown) tilt at an angle (b) towards the transparent panel 22. Comparing to the first preferred embodiment, with the same detection range (a), the tilting of the second preferred embodiment allows for greater coverage of the light emitted into the touch surface 221, and reduces the size of a non responsive area closer to the optical sensors 24.

To conclude, the present invention overcomes the drawbacks of the conventional optical touch panel device. Firstly, application of the optical touch panel device 2 is greatly extended when a fully flattop touch surface is achieved by disposing the optical sensors 24 between the transparent panel 22 and the display panel 23 with no component disposed on the touch surface 22 of the transparent panel 22. Secondly, the cost of the optical touch panel device 2 is reduced drastically as the light-emitting portion 12 of the stylus 1 directly emits the light for detection by the light sensors 24 and use of a costly retro-reflector is eliminated. Thirdly, excellent water and dust proofing abilities are achieved when there is no component disposed on the touch surface 221 to form a gap therewith.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. An optical touch panel device adapted to be operable with a stylus, the stylus having a touch portion and a light-emitting portion that is connected to the touch portion and that emits light when the touch portion is touched, said optical touch panel device comprising:
a back housing having an external hole-defining surface that defines an opening;
a transparent panel attached to said back housing, sealing said opening and being flush with said hole-defining surface of said back housing;
at least two optical sensors spaced apart from each other, disposed in said back housing, and adapted to sense the light from the light-emitting portion of the stylus when the touch portion of the stylus touches said transparent panel; and
a processing module coupled to said optical sensors for determining a position on said transparent panel at which the touch portion of the stylus touches based on the light detected by said optical sensors.

2. The optical touch panel device of claim 1, further comprising a display panel disposed inside said back housing and spaced apart from said transparent panel, said optical sensors being disposed between said transparent panel and said display panel.

3. The optical touch panel device of claim 2, further comprising a support member that is clamped cooperatively by said display panel and said transparent panel to provide a space therebetween for accommodating said optical sensors.

4. The optical touch panel device of claim 3, wherein said support member is waterproof and is configured as a strip extending along the junction between said transparent panel and said back housing.

5. The optical touch panel device of claim 1, wherein said optical sensors tilt at an angle towards said transparent panel.

6. An optical touch panel system comprising:
a stylus that has a touch portion and a light-emitting portion connected to said touch portion and emitting light when said touch portion is touched; and
an optical touch panel device that includes
a back housing having an external hole-defining surface that defines an opening,
a transparent panel attached to said back housing, sealing said opening and being flush with said hole-defining surface of said back housing,
at least two optical sensors spaced apart from each other, disposed in said back housing, and sensing light from said light-emitting portion of said stylus when said touch portion of said stylus touches said transparent panel, and
a processing module coupled to said optical sensors for determining a position on said transparent panel at which said touch portion of said stylus touches based on the light detected by said optical sensors.

7. The optical touch panel system of claim 6, wherein said stylus further has a control module connected to said touch portion and said light-emitting portion, said control module actuating the light-emitting action of said light-emitting portion when said touch control portion is touched, and stopping the light-emitting action when said touch portion is not touched.

8. The optical touch panel system of claim 7, wherein said light-emitting portion of said stylus is elongated.

9. The optical touch panel system of claim 6, wherein said optical touch panel device further includes a display panel disposed inside said back housing and spaced apart from said transparent panel, said optical sensors being disposed between said transparent panel and said display panel.

10. The optical touch panel system of claim 9, wherein said optical touch panel device further includes a support member that is clamped cooperatively by said display panel and said transparent panel to provide a space therebetween for accommodating said optical sensors.

11. The optical touch panel system of claim 10, wherein said supporting member is waterproof and is configured as a strip extending along the junction between said transparent panel and said back housing.

12. The optical touch panel system of claim 6, wherein said optical sensors tilt at an angle towards said transparent panel.
